(19) United States
(12) Patent Application Publication
(10) Pub. No.: US 2014/0269737 A1
(43) Pub. Date: Sep. 18, 2014

(54) SYSTEM, METHOD AND APPARATUS FOR LSP SETUP USING INTER-DOMAIN ABR INDICATION

(71) Applicants: PRADEEP G. JAIN, SUNNYVALE, CA (US); KANWAR D. SINGH, MOUNTAIN VIEW, CA (US); SRIKRISHNAN VENKATARAMAN, MOUNTAIN VIEW, CA (US); NISHA DESAI, MOUNTAIN VIEW, CA (US)

(72) Inventors: PRADEEP G. JAIN, SUNNYVALE, CA (US); KANWAR D. SINGH, MOUNTAIN VIEW, CA (US); SRIKRISHNAN VENKATARAMAN, MOUNTAIN VIEW, CA (US); NISHA DESAI, MOUNTAIN VIEW, CA (US)

(21) Appl. No.: 13/840,421

(22) Filed: Mar. 15, 2013

(51) Int. Cl. H04L 12/723

(52) U.S. Cl. CPC H04L 45/50
USPC 370/400

(57) ABSTRACT

A system, method and apparatus for causing network routers such as Area Border Routers (ABRs) to perform an ERO expansion in response to ERO expansion trigger indicia included within an RSVP Path message.

### CROSS-REFERENCE TO RELATED APPLICATION

This application claims the benefit of pending U.S. Provisional Patent Application Ser. No. 61/676,796, filed Jul. 27, 2012, entitled SYSTEM, METHOD AND APPARATUS FOR IMPROVED MPLS MANAGEMENT, which application is incorporated herein by reference in its entirety.

### FIELD OF THE INVENTION

The invention relates to the field of communication networks such as multi-protocol label switching (MPLS) networks and, more particularly but not exclusively, to an Area Border Router (ABR) awareness mechanism for Label Switched Paths (LSP).

### BACKGROUND

Multiprotocol Label Switching (MPLS) enables efficient delivery of a wide variety of differentiated, end-to-end services. Multiprotocol Label Switching (MPLS) traffic engineering (TE) provides a mechanism for selecting efficient paths across an MPLS network based on bandwidth considerations and administrative rules. Each label switching router maintains a TE link state database with a current network topology. Once a path is computed, TE is used to maintain a forwarding state along that path.

As described in more detail in various Internet Engineering Task Force (IETF) Requests for Comment (RFC), such as RFC4726 and RFC5151, an Area Border Router (ABR) is a router located between several areas in a hierarchical Open Shortest Path First (OSPF) network. ABRs maintain topology information from multiple areas. In the case of Resource Reservation Protocol (RSVP) Inter-Domain TE-LSPs of type Contiguous LSP each Area Border Router (ABR) triggers a path computation (also referred to as an Explicit Route Object (ERO) expansion), before forwarding the RSVP Path message downstream. Thus, each ABR is responsible for calculating TE constrained path for its successive TE-Domain(s) or Area(s).

Every such ABR that triggers path computation for its TE-Domain can have multiple equal-cost paths and has to choose one of them. Currently this is achieved by configuring and signaling the ABR node as a so-called “loose-hop” via a RSVP Hop object, and configuring an option on the ABR to perform a Constrained Shortest Path First (CSPF) computation for the next segment.

Unfortunately, this mechanism is unwieldy and does not scale well.

### SUMMARY

Various deficiencies in the prior art are addressed by systems, methods and apparatus for causing network routers such as Area Border Routers (ABRs) to perform an ERO expansion in response to ERO expansion trigger indicia included within an RSVP Path message.

Various embodiments provide systems, methods and apparatus forwarding, toward a next hop in a label switched path (LSP), an RSVP Path message including ERO expansion trigger indicia associated with one or more provider edge (PE) routers.

Various embodiments provide systems, methods and apparatus for triggering a Constrained Shortest Path First (CSPF) computation at one or more provider routers within a label switched path (LSP) by forwarding to a next hop an RSVP Path message including an Explicit Route Object (ERO) having an ERO sub-object including a first flag, said first flag being set to a first state to indicate that a router is an Area Border Router (ABR) and set to a second state to indicate that the router is not an ABR.

### BRIEF DESCRIPTION OF THE DRAWINGS

The teachings of the present invention can be readily understood by considering the following detailed description in conjunction with the accompanying drawings, in which:

FIG. 1 depicts an exemplary network benefiting from the various embodiments;

FIG. 2 depicts a flow diagram of a method according to one embodiment; and

FIG. 3 depicts a high-level block diagram of a computing device suitable for use in performing functions described herein.

To facilitate understanding, identical reference numerals have been used, where possible, to designate identical elements that are common to the figures.

### DETAILED DESCRIPTION

Various embodiments will be described within the context of a network supporting Resource Reservation Protocol (RSVP) Inter-Domain Traffic Engineering Label Switched Paths (TE-LSPs) of type Contiguous LSP, such as defined in IETF RFC4726 and RFC5151, each of which is incorporated by reference in its respective entirety.

FIG. 1 depicts a high-level block diagram of a communication network benefiting from various embodiments. Specifically, the network 100 of FIG. 1 provides a Multi-Protocol Label Switching (MPLS) network supporting Resource Reservation Protocol (RSVP) Inter-Domain Traffic Engineering Label Switched Paths (TE-LSPs) of type Contiguous LSP. The network may be modified by those skilled in the art to use other MPLS related protocols rather that the exemplary protocol discussed herein.

The network 100 includes three IP/MPLS communication networks (CN) 105-1, 105-2 and 105-3, where each communication network 105 is associated with a respective area. The network 100 also includes at least one network management system (NMS) 120. As depicted, NMS 120 is operative to control a plurality of routers 110-1 through 110-11 distributed among the communication network areas 105-1 through 105-3.

First area 105-1 comprises the first 110-1, second 110-2 and fourth 110-4 routers, second area 105-2 comprises the third 110-3, fifth 110-5, sixth 110-6 and seventh 110-7 routers, while third area 105-3 comprises the eighth 110-8, ninth 110-9, tenth 110-10 and eleventh 110-11 routers. It is noted that various routers are interconnected to form thereby paths. Specifically, the following sequence of router connections is depicted in FIG. 1, where adjacent named routers are connected or linked to each other: R1-R2-R3-R6-R8-R10-R11-R9-R7-R5-R4-R1. In addition, R3 is connected/linked to each of R4, R5 and R7, while R7 is additionally connected/linked to R8.

The third 110-3 (R3) and fifth 110-5 (R5) routers operate as Area Border Routers (ABRs) separating the first 105-1 and second 105-2 areas. Similarly the sixth 110-6 (R6) and seventh 110-7 (R7) routers operate as ABRs separating the second 105-2 and third 105-3 areas.

Data packets or datagrams are routed according to ingress and egress virtual connection (VC) labels on a per-service basis. The VC labels are used by the PE routers 130 for demultiplexing traffic arriving from different services over the same set of LSP tunnels.

The NMS 120 is a network management system adapted for performing the various management functions described herein. The NMS 120 is adapted to communicate with nodes of CN 105. The NMS 120 may also be adapted to communicate with other operations support systems (e.g., Element Management Systems (EMSs), Topology Management Systems (TMSs), and the like, as well as various combinations thereof).

The NMS 120 may be implemented at a network node, network operations center (NOC) or any other location capable of communication with the CN 105 and various elements related thereto. The NMS 120 may support user interface capabilities to enable one or more users to perform various network management, configuration, provisioning or control related functions (e.g., enter information, review information, initiate execution of various methods as described herein and the like). Various embodiments of the NMS 120 are adapted to perform functions as discussed herein. The NMS 120 may be implemented as a general purpose computing device or specific purpose computing device, such as described below with respect to FIG. 3.

The NMS 120 and the various routers 110 operate to support Resource Reservation Protocol (RSVP) Inter-Domain Traffic Engineering Label Switched Paths (TE-LSPs) of type Contiguous LSP.

Various embodiments utilize an RSVP path message modified to include additional information adapted to identify which nodes are ABRs or are to be treated as ABRs. In this manner, the need to define ABR nodes as loose hop nodes is avoided.

In one embodiment, an RSVP path message created by an ingress node (e.g., router R1) includes an Explicit Route Object (ERO) such as defined in IETF RFC 3209, and further includes ERO sub-object information identifying specific routers as ABRs, or routers to be treated as ABRs. When the ERO is present, the Path message is forwarded towards its destination along a path specified by the ERO. Each node along the path records the ERO in its path state block. Nodes may also modify the ERO before forwarding the Path message. This mechanism is adapted by including within the ERO information identifying ABR nodes and/or nodes to be treated as ABR nodes.

Various embodiments contemplate nodes or routers being configured to be responsive to the various RSVP path messages defined herein to perform an ERO expansion, Constrained Shortest Path First (CSPF) computation and the like as described herein.

Various embodiments contemplate nodes or routers being configured to be responsive to network management system commands such as to modify the ERO information identifying ABR nodes and/or nodes to be treated as ABR nodes.

TLV Attribute

Various embodiments enable the communication of ABR indicative information using a new flag or bit setting in an existing LSP attribute or, optionally, a newly defined LSP attribute encoded in Type-Length-Value (TLV) format.

Various embodiments enable the communication of loose-loose hop indicative information using a new flag or bit setting in an existing LSP attribute or, optionally, a newly defined LSP attribute encoded in Type-Length-Value (TLV) format.

In one embodiment, to specifically indicate which node or nodes in an LSP are to be treated as an ABR, one or more of the bits within an ERO sub-object, existing LSP attribute TLV and/or newly defined LSP attribute TLV is set or cleared, such as an attribute TLV according to RFC5420.3. For example, attributes carried by new objects are encoded within TLVs as follows, where a Type Field is an identifier of the TLV, a Length Field is used to indicate the total length of the TLV in octets, and a Value Field is used to carry the data.

[chemical structure]

In one embodiment, specific bits within the Reserved field (or other field) are used to indicate whether or not the hop having an address indicated by the ERO sub-object is an ABR, whether the hop is to be considered as loose-loose hop, and so on. The specific bits denoted herein to provide these indications are for illustrative purposes only. Different bits within the reserved field or other fields may be used to provide these indications.

For example, in one embodiment a specific bit number(s) (e.g., bit 0, bit 3, bit 4 or some other bit) is assigned a designation of “ABR Bit” or “ABR Flag” or some other designation. If the ABR Bit or Flag is set, then the hop indicated by the ERO sub-object is to be treated as an ABR such that an ERO expansion or Constrained Shortest Path First (CSPF) computation is to be performed. Optionally, a different specific bit number is assigned a designation of “loose-loose Bit” (“L Bit”) or “loose-loose Flag” (“L Flag”) or some other designation. If the L Bit or L Flag is set, then the hop indicated by the ERO sub-object is to be treated as a loose-loose hop.

Thus, in various embodiments an indication of an ABR node and/or a loose-loose hop is provided via a LSP attribute encoded in Type-Length-Value (TLV) format. In particular, a state of a predefined bit of a LSP_ATTRIBUTES object is used to indicate an ABR node and/or a loose-loose hop.

In various embodiments, modifications to selected cost constraint are communicated via additional bits in the LSP_ATTRIBUTES object. For example, additional bits can be used to provide additional information for use in the LSP path calculation, such as service provider preferences, user preferences, historical or instantaneous loading/congestion and so on. Each of these and other factors may be assigned a cost and the use or weight of this cost may be adapted over time.

Thus, various embodiments contemplate an LSP_ATTRIBUTES object, ERO object, ERO sub-object and the like having one or more bits or flags indicative of whether a node is an ABR and/or loose-loose node. Additional embodiments contemplate one or more bits associated with a modification to the selected metric or cost constraint due to any of service provider preferences, user preferences, historical or instantaneous loading/congestion and the like.

In various embodiments, the ABR Bit comprises bit 0 of eh Reserved Field and the L Bit comprises bit 1 of the Reserved Field.

As previously noted, each of the ABRs depicted in the network 105 of FIG. 1 (e.g., routers R3, R6, R5 and R7) receives an RSVP path message including ABR and/or loose-loose indicator, and performs a path computation (also referred to as an ERO expansion) before forwarding the RSVP Path message toward a next router downstream.

The LSP setup is typically defined at the Ingress Label Edge Routers (LERs). Thus, for example, the various ABR and L flags may be set to appropriate states as the LER generates an ERO for the LSP. In various embodiments, the various ABR and L flags may be adapted to be subsequent nodes (ABR or otherwise) within the LSP, such as in response to a NMS command.

FIG. 2 depicts a flow diagram of a method according to one embodiment. Specifically, FIG. 2 depicts a method 200 for triggering ERO expansion in a node selected for treatment as an ABR within an LSP.

At step 210, an ingress LER selects various nodes to form thereby an LSP between the ingress LER and an egress LER.

At step 220, one or more nodes are identified as ABR nodes or to be treated as ABR nodes. Referring to box 225, the ABR identified nodes may be preferred LSP nodes, backup LSP nodes, alternative LSP nodes and/or other nodes.

At step 230, any nodes to be treated as loose-loose hop nodes are identified. As with the ABR nodes identified at step 220/225, the loose-loose hop nodes may be preferred LSP nodes, backup LSP nodes, alternative LSP nodes and/or other nodes.

At step 240, the ABR nodes and any loose-loose nodes are indicated as such within the context of an RSVP Path message. Referring to box 245, such indications may be made according to an ABR Bit, ABR Flag, L Bit, L Flag and the like as discussed herein via any of a new or existing LSP attribute encoded in a Type-Length-Value (TLV) format, via an ERO object, via an ERO sub-object and the like.

At step 250, the RSVP Path message is transmitted toward a next hop.

At step 260, the RSVP message is received by a node (e.g., next hop node) such as a primary LSP router or ABR, secondary LSP router or ABR or other node.

At step 270, the receiving node inspects the RSVP Message to determine if it is associated with an ABR and/or loose-loose identification, and responds as appropriate.

If defined as an ABR then the receiving node performs an ERO expansion whether or not the next hop is a loose hop (i.e., not directly connected to the receiving node). Thus, even if the next hop is a strict hop (i.e., directly connected to the receiving node), an ERO expansion is performed. If defined as loose-loose, then an ERO expansion operation is performed to reach the next loose hop.

At step 280, the receiving node optionally modifies the RSVP message, such as in response to NMS commands, EOR expansion and the like. Modification to the RSVP Path message may be performed using any of the techniques described herein, such as described above with respect to steps 210-240.

At step 290, the receiving node forwards the modified or unmodified RSVP Path message toward the next hop.

Example of LSP Setup with ABR Node Indication

The various embodiments described herein provide a mechanism for LSP setup with ABR node indication in, illustratively, an ERO sub-object. As an example, and referring to FIG. 1, assume that a path of an Inter-Domain TE LSP T1 from R1 (Ingress LER) to R11 (Egress LER) is defined on R1 as the following loosely routed path R1-R3(ABR)-R8(ABR)-R11. According to various embodiments, the following occurs:

The Ingress LER creates an RSVP Path message with ERO as specified in RFC 3209, and sets the ABR Bit or Flag as discussed above to indicate that hops R3, R8 and R11 are the ABR nodes.

When the path message is received by a node defined as an ABR node (such as R3 or R8), the receiving node performs a CSPF computation to reach the next ABR in the ERO. In this manner, a rapid setup of an inter-domain TE LSP is provided.

Advantageously, the various embodiments eliminate the need to necessarily define ABR nodes as loose hop nodes and having a configuration knob on the ABR nodes to perform ERO expansion. Further, since an ABR node may be indicated in, illustratively, the ERO sub-object, it can also be a strict hop. In this manner, additional flexibility is provided by allowing non-ABR nodes (i.e., routers between ABR nodes) to be defined or treated as ABR nodes.

Examples of LSP Setup with ABR as Loose-Loose Hop

The various embodiments described herein provide a mechanism for LSP setup with loose-loose hop indication in, illustratively, an ERO sub-object. As an example, and referring to FIG. 1, assume that a path of an Inter-Domain TE LSP T1 from R1 (Ingress LER) to R11 (Egress LER) is defined on R1 as the following loosely routed path R1-R3(ABR)-R8(ABR)-R11. According to various embodiments, the following occurs:

The Ingress LER creates an RSVP Path message with ERO as specified in RFC 3209, and sets the ABR Bit or Flag as discussed above to indicate that hops R3, R8 and R11 are the ABR nodes.

The Ingress LER additionally sets the L Bit or Flag as discussed above to indicate that one or more ABR nodes are loose-loose (e.g., L bit in the ERO sub-object is set in addition to ABR bit).

For a hop considered as loose-loose, when the LSP setup does not succeed using the loose hop defined in the ERO sub-object (e.g., network reachability problem or constraints not being met via the loose hop), the hop may be avoided (excluded) such that LSP setup operates to bypass the hop. Similarly, when the LSP setup does succeed using the loose hop defined in the ERO sub-object (e.g., network reachability problem resolved or constraints now met via the loose hop), the hop may now be included such that LSP setup may operate to include the hop.

If the ingress LER determines that a path can be found to a loose-loose ABR node (i.e., the node is now reachable), then the RSVP Path message to establish the LSP would be generated and sent towards the next hop.

When the path message is received by a node defined as an ABR node (such as R3 or R8), the receiving node performs a CSPF computation to reach the next ABR in the ERO. In this manner, a rapid setup of an inter-domain TE LSP is provided. If due to network failures and the like, the receiving node (e.g., R3) is unable to find a path to a loose-loose defined next node (e.g., R8), then the receiving node would perform an ERO expansion to determine a path toward the egress LER (e.g., R11).

In this manner, LSP setup is achieved while avoiding ABR node R8, which is unreachable, outside of the required constraints, possessing insufficient bandwidth or QoS and the like).

FIG. 3 depicts a high-level block diagram of a computing device, such as a processor in a telecom network element, suitable for use in performing functions described herein, such as the various network management functions, LSR functions, encapsulation functions, routing/path functions and so on associated with the various elements described above with respect to the figures.

As depicted in FIG. 3, computing device 300 includes a processor element 303 (e.g., a central processing unit (CPU) and/or other suitable processor(s)), a memory 304 (e.g., random access memory (RAM), read only memory (ROM), and the like), a cooperating module/process 305, and various input/output devices 306 (e.g., a user input device (such as a keyboard, a keypad, a mouse, and the like), a user output device (such as a display, a speaker, and the like), an input port, an output port, a receiver, a transmitter, and storage devices (e.g., a persistent solid state drive, a hard disk drive, a compact disk drive, and the like)).

It will be appreciated that the functions depicted and described herein may be implemented in software and/or in a combination of software and hardware, e.g., using a general purpose computer, one or more application specific integrated circuits (ASIC), and/or any other hardware equivalents. In one embodiment, the cooperating process 305 can be loaded into memory 304 and executed by processor 303 to implement the functions as discussed herein. Thus, cooperating process 305 (including associated data structures) can be stored on a computer readable storage medium, e.g., RAM memory, magnetic or optical drive or diskette, and the like.

It will be appreciated that computing device 300 depicted in FIG. 3 provides a general architecture and functionality suitable for implementing functional elements described herein or portions of the functional elements described herein.

It is contemplated that some of the steps discussed herein as software methods may be implemented within hardware, for example, as circuitry that cooperates with the processor to perform various method steps. Portions of the functions/elements described herein may be implemented as a computer program product wherein computer instructions, when processed by a computing device, adapt the operation of the computing device such that the methods and/or techniques described herein are invoked or otherwise provided. Instructions for invoking the inventive methods may be stored in tangible and non-transitory computer readable medium such as fixed or removable media or memory, transmitted via a tangible or intangible data stream in a broadcast or other signal bearing medium, and/or stored within a memory within a computing device operating according to the instructions.

Although various embodiments which incorporate the teachings of the present invention have been shown and described in detail herein, those skilled in the art can readily devise many other varied embodiments that still incorporate these teachings. Thus, while the foregoing is directed to various embodiments of the present invention, other and further embodiments of the invention may be devised without departing from the basic scope thereof. As such, the appropriate scope of the invention is to be determined according to the claims.

What is claimed is:

1. A method, comprising:
forwarding, toward a next hop in a label switched path (LSP), an RSVP Path message including ERO expansion trigger indicia associated with one or more provider edge (PE) routers.

2. The method of claim 1, wherein said ERO expansion trigger indicia is included within said RSVP Path message at an Ingress Label Edge Router (LER).

3. The method of claim 1, wherein said one or more PE routers associated with said ERO expansion trigger indicia comprise Area Border Routers (ABRs).

4. The method of claim 3, further comprising adapting said ERO expansion trigger indicia within said RSVP Path message at an ABR.

5. The method of claim 1, further comprising:
receiving, at a PE router, said RSVP Path message including ERO expansion trigger indicia; and
in response to said PE Router being identified by said ERO expansion trigger indicia, performing an ERO expansion operation to reach a next hop in said LSP.

6. The method of claim 5, wherein said steps are performed by each Area Border Router (ABR) along the LSP.

7. The method of claim 2, wherein said Ingress LER adapts said PE Routers associated with said ERO expansion trigger indicia in response to a control message received from a network management system (NMS).

8. The method of claim 1, wherein said ERO expansion trigger indicia is provided via a LSP attribute encoded in Type-Length-Value (TLV) format.

9. The method of claim 8, wherein a state of a predefined bit of a LSP_ATTRIBUTES object is used to indicate whether a PE Router is selected to perform an ERO expansion operation.

10. The method of claim 8, wherein said LSP_ATTRIBUTES object comprises one or more bits indicative of a PE router selected to perform an ERO expansion operation.

11. The method of claim 8, wherein a state of a first predefined bit of a LSP_ATTRIBUTES object is used to indicate whether a PE Router is an ABR.

12. The method of claim 11, wherein a state of a second predefined bit of the LSP_ATTRIBUTES object is used to indicate whether a PE Router is associated with a loose-loose hop.

13. The method of claim 8, wherein said LSP attribute comprises an Explicit Route Object (ERO) sub-object.

14. A method for triggering a Constrained Shortest Path First (CSPF) computation at one or more provider routers within a label switched path (LSP), the method comprising:
forwarding to a next hop a RSVP Path message including an Explicit Route Object (ERO) having an ERO sub-object including a first flag, said first flag being set to a first state to indicate that a router is an Area Border Router (ABR) and set to a second state to indicate that the router is not an ABR.

15. The method of claim 14, wherein said ERO sub-object further including a second flag, said second flag being set to a first state to indicate that a router is associated with a loose-loose hop, and set to a second state to indicate that the router is not associated with a loose-loose hop.

16. A telecom network element, comprising a processor configured for:
forwarding, toward a next hop in a label switched path (LSP), an RSVP Path message including ERO expansion trigger indicia associated with one or more provider edge (PE) routers.

17. A tangible and non-transient computer readable storage medium storing instructions which, when executed by a computer, adapt the operation of the computer to provide a method, comprising:
forwarding, toward a next hop in a label switched path (LSP), an RSVP Path message including ERO expansion trigger indicia associated with one or more provider edge (PE) routers.

18. A computer program product wherein computer instructions, when executed by a processor in a telecom network element, adapt the operation of the telecom network element to provide a method, comprising:
forwarding, toward a next hop in a label switched path (LSP), an RSVP Path message including ERO expansion trigger indicia associated with one or more provider edge (PE) routers.
